(19) United States
(12) Patent Application Publication
(10) Pub. No.: US 2024/0239668 A1
(43) Pub. Date: Jul. 18, 2024

(54) PRODUCTION OF ELECTROCHEMICALLY ACTIVE SILICON FROM CLAY MINERALS

(71) Applicant: Brigham Young University, Provo, UT (US)

(72) Inventors: Dean Wheeler, Orem, UT (US); Nathan Clarke, Spanish Fork, UT (US); Brian Mazzeo, Provo, UT (US)

(21) Appl. No.: 18/562,064

(22) PCT Filed: May 18, 2022
(86) PCT No.: PCT/US2022/072407

§ 371 Date: Nov. 17, 2023

Related U.S. Application Data
(60) Provisional application No. 63/190,032, filed on May 18, 2021.

(51) Int. Cl. C01B 33/023

(52) U.S. Cl. CPC C01B 33/023; C01P 2002/01; C01P 2002/02; C01P 2002/08; C01P 2004/03; C01P 2004/04; C01P 2004/13; C01P 2004/32; C01P 2004/64

(57) ABSTRACT

A method includes etching metallic impurities from an aluminosilicate mineral in a liquid acid etchant and separating solids including silica from the liquid acid etchant. The method further includes reducing the silica in the separated solids to silicon using a solid reducing agent resulting in a silicon-residual silica composite, removing aluminum chloride from the silicon-residual silica composite, dissolving oxides of the solid reducing agent in an acid solution, and separating silicon-residual silica solids remaining in the acid solution from the acid solution. The separated silicon-residual silica solids are dried to produce a clay mineral-derived silicon product.

### CROSS-REFERENCE TO RELATED APPLICATION

This application claims the benefit of, and priority to, U.S. Provisional Patent Application No. 63/190,032, filed on May 18, 2021, entitled “Production of electrochemically active silicon material from halloysite,” which is hereby incorporated by reference in its entirety herein.

### TECHNICAL FIELD

This description relates to extraction of high purity silicon powders from clay minerals.

### BACKGROUND

Kaolinite is an important industrial mineral, and halloysite is becoming increasingly important for nanotechnology applications which take advantage of its tubular habit. Halloysite or kaolinite can be used as a replacement for graphite (e.g., carbon nanotubes) in high-tech applications such as hydrogen storage, water purification, carbon capture, soil remediation and renewable energy. For example, halloysite-derived silicon (HDS) and other forms of nano-silicon can be used as anode material in lithium-ion batteries.

### SUMMARY

In a general aspect, a method includes etching metallic impurities from an aluminosilicate mineral in a liquid acid etchant and separating solids including silica from the liquid acid etchant. The method further includes reducing the silica in the separated solids to silicon using a solid reducing agent resulting in a silicon-residual silica composite, removing aluminum chloride from the silicon-residual silica composite, dissolving oxides of the solid reducing agent in an acid solution, and separating silicon-residual silica solids remaining in the acid solution from the acid solution. The separated silicon-residual silica solids are dried to produce a clay mineral-derived silicon product.

In a general aspect, a clay mineral-derived silicon product is prepared by a hydrofluoric acid (HF)-free process. The product includes silicon nano structures. and silica in a range of about 5 to 25 weight percentage of the product. In an example implementation, the silica comprises about 5 to 12 weight percentage of the product.

In example implementations, the silicon nano structures in the clay mineral-derived silicon product include silicon nano tubes and nano-size silicon spheres and particles. The silicon nano structures can include amorphous silicon particles.

In example implementations, the clay mineral-derived silicon product further includes electronically conductive carbon mixed with the silicon nano structures. The electronically conductive carbon can include reduced graphene oxides (rGO).

### BRIEF DESCRIPTION OF THE DRAWINGS

FIG. 1 schematically illustrates an example method for producing electroactive nano-structured silicon from an aluminosilicate clay mineral, in accordance with the principles of the present disclosure.

FIG. 2 is a transmission electron micrograph (TEM) image illustrating unique nanotubes found in mined halloysite mineral.

FIG. 3A is an illustrative scanning electron microscope image of unprocessed halloysite.

FIG. 3B is an illustrative scanning electron microscope image of halloysite-derived silicon (HDS) powder produced using the method of FIG. 1.

FIG. 4 is a flow diagram schematically illustrating an example method for producing silicon powder (e.g., HDS) from clay minerals.

FIG. 5 is a flow diagram schematically illustrating a reduction method for producing silicon powder (e.g., HDS) from clay minerals.

In the drawings, which are not necessarily drawn to scale, like reference symbols may indicate like and/or similar components (elements, structures, etc.) in different views. The drawings illustrate, by way of example, but not by way of limitation, various implementations discussed in the present disclosure. Reference symbols shown in one drawing may or may not be repeated for the same, and/or similar elements in related views. Further, reference symbols that are repeated in multiple drawings may not be specifically discussed with respect to each of those drawings but are provided for context between related views. Also, not all like elements in the drawings may be specifically referenced with a reference symbol when multiple instances or portions of an element are illustrated.

### DETAILED DESCRIPTION

Kaolinite is an aluminosilicate clay mineral with the empirical formula Al₂Si₂O₅(OH)₄. Kaolinite typically has a platy (i.e., plate-like) sheet structure. Halloysite is another aluminosilicate clay mineral with a similar composition except that it can contain additional water molecules between the layers. In its fully hydrated form, halloysite has the formula Al₂Si₂O₅(OH)₄-2H₂O. Halloysite can have a tubular morphology (e.g., as halloysite nano tubes (HNTs)) or display spheroidal or plate-like morphologies.

Methods for producing electroactive nano-structured silicon from clay minerals (e.g., halloysite and kaolinite) are described herein.

Natural clay minerals (e.g., halloysite) usually exist with impurities (e.g., illite, quartz, feldspar, chlorite, gibbsite, salts, and oxides, etc.), in which the size distribution of nano tubes ranges extensively. The disclosed methods are designed to produce high purity silicon nano structures (e.g., silicon nano tubes, nano-size spheres, or particles, etc.) from the natural clay minerals.

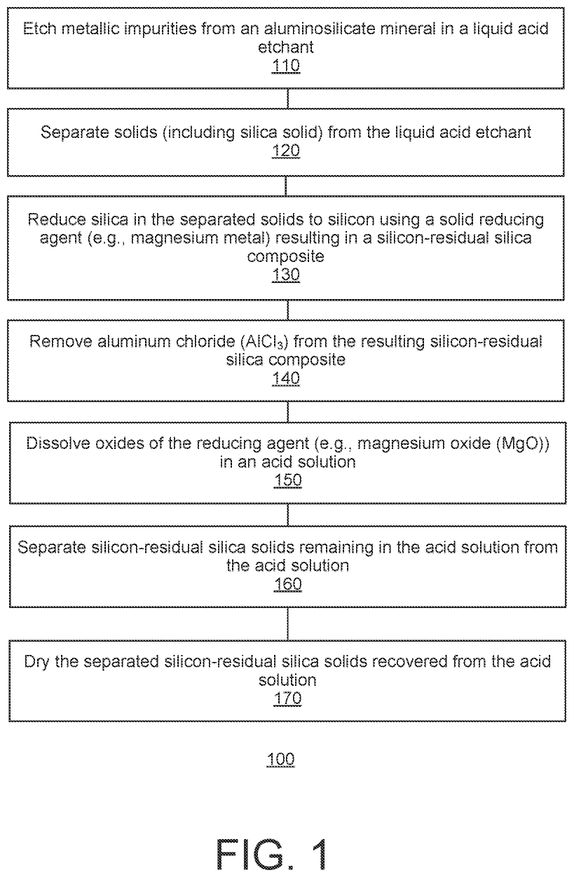

FIG. 1 schematically illustrates an example method 100 for producing nano-structured silicon powder from an aluminosilicate clay mineral (e.g., halloysite), in accordance with the principles of the present disclosure.

Method 100 involves extracting (purifying) silicon (Si) powder (e.g., halloysite-derived silicon (HDS)) from natural clay minerals using a combination of large-scale industrial processes including acid leaching, low-temperature thermal processing, and scalable solid-liquid separations. Method 100 is less energy-intensive and less chemical-intensive (i.e., has fewer chemical steps) than traditional processes for Si powder extractions (e.g., processes that involve hydrofluoric acid (HF) etching or separation) from aluminosilicate clay minerals.

An example clay mineral-derived Si powder product (e.g., HDS produced by method 100) includes silicon nano structures (e.g., silicon nano tubes, nano-size spheres or particles, etc.) and an amount of silica in a range of about 5 to 25 weight percentage (e.g., 5 wt. %, 8 wt. %, 10 wt. %, 12 wt. %, 15 wt. %, 18 wt. %, 20 wt. %, or 25 wt. % of silica). A silica range of 5 wt. %, to 12 wt. % may be a critical range for HDS used for lithium battery anode applications. HDS with a small amount of silica content (e.g., silica content between 5 wt. %, to 12 wt. %) may be produced by method 100 using low temperature chemical reactions (i.e., with reaction temperatures between about 250° C. and 300° C.). The small amount of silica content and the low chemical reaction temperatures can help preserve at least some of the tubular or rod-like structure of the clay mineral (e.g., halloysite) in the HDS that may be critical for high-performance of the HDS as an anode material.

As shown in FIG. 1, method 100 includes etching metallic impurities from an aluminosilicate mineral (e.g., a halloysite or kaolinite mineral) in a liquid acid etchant (110) and separating solids (including silica solid) from the liquid acid etchant (120). Method 100 further includes reducing silica to silicon in the separated solids using a solid reducing agent (e.g., magnesium metal) (130), removing aluminum salts (e.g., aluminum chloride (AlCl₃)) from the resulting silicon-residual silica composite (140), and dissolving oxides of the reducing agent (e.g., magnesium oxide (MgO)) in an acid solution (150). Method 100 additionally includes separating silicon-residual silica solids remaining in the acid solution from the acid solution (160) and drying the separated silicon-residual silica solids (e.g., halloysite-derived silicon (HDS)) recovered from the acid solution (170).

In example implementations, method 100 can be used to produce HDS from halloysite mineral that may be found worldwide in natural geological deposits for incorporation into high-performance anode films (e.g., in lithium batteries). An example source of the halloysite mineral suitable for incorporation into high-performance anode films can, for example, be the natural deposits located at, or in the vicinity of, Dragon Mine, Tintic District, Silver City, Utah (USA) (that is presently mined, for example, by Applied Minerals Inc. (AMI) of Eureka, Utah).

The mined halloysite can have a unique nano-tube/nano-porous structure allowing HDS nanostructures to be formed without expensive metallurgical, templating, gaseous, or other top-down engineering processes. Additionally, halloysite's native structure and metallic impurities (e.g., aluminum (Al)), may have beneficial effects such as an increase in electronic conductivity of the HDS material or an enhancement of cycling stability in lithium batteries.

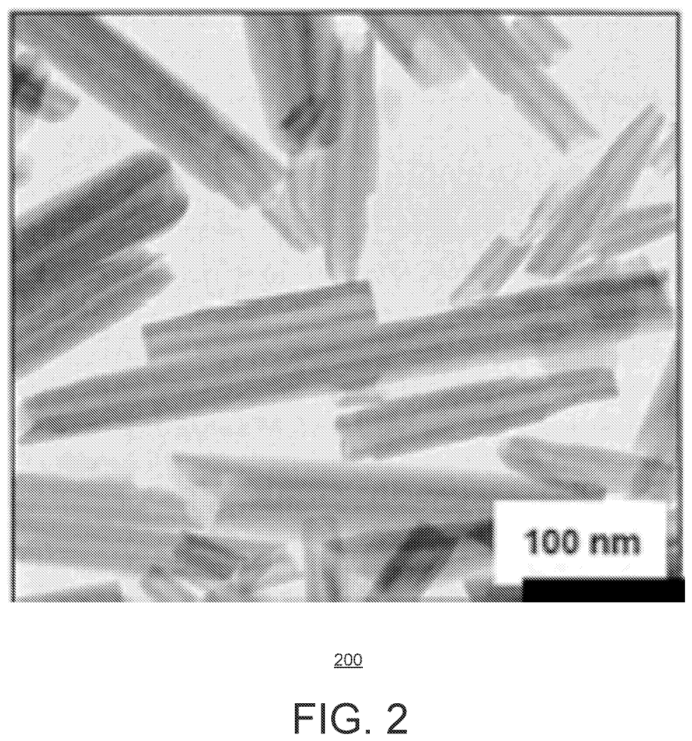

FIG. 2 is a transmission electron micrograph (TEM) image 200 illustrating the unique nanotubes found in the mined halloysite mineral. As shown in TEM image 200 (with visual comparison to the 100 nm scale overlaid on the image), the halloysite's unusual tubular aluminosilicate structure can include nano-tubes with a length in a range of about 0.2 μm to about 2.0 μm, an outer diameter of about 50 nm to about 70 nm, and a lumen (hollow center) with an inner diameter of about 15 nm to about 10 nm.

In example implementations, method 100 can be used to produce HDS powder suitable for battery anode applications from clay minerals (e.g., halloysite mineral supplied by AMI or other clay minerals) without hydrofluoric acid treatment. In addition to pure Si particles, the HDS powder produced by method 100 can include several wt. % of residual silica (e.g., 5 wt. %, to 15 wt. % of silica).

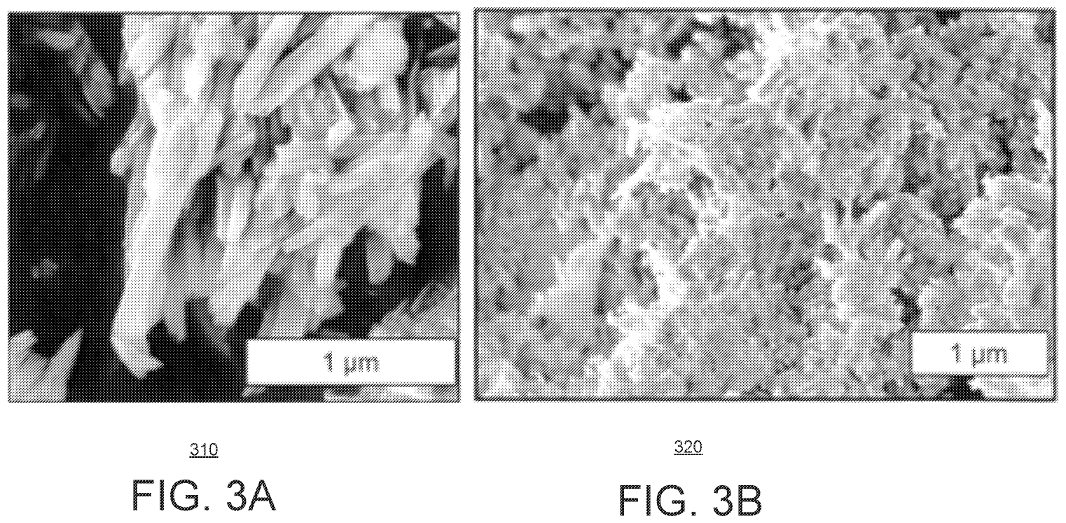

The HDS powder produced using method 100 may preserve at least some of the nano-tube morphology of the raw mineral (as shown for example in FIG. 3B) suitable for battery anode applications).

FIGS. 3A and 3B are illustrative scanning electron microscope images (e.g., image 310 and image 320, respectively) of unprocessed halloysite supplied by AMI, and HDS powder produced from the halloysite using method 100.

In an example implementation, a HDS powder produced using method 100 can contain about 8 to 18 wt. % of residual silica. The HDS powder can be mixed with a carbon additive and a binder to make, for example, a 70 Wt % Si anode for a lithium battery.

In example implementations, the hydrofluoric acid (HF) free chemistries used for the various steps 110-170 of method 100 may be tailored to produce HDS of specific compositions (e.g., compositions with specific percentages of residual silica, specific percentages of impurities or other additives such as aluminum, carbon, magnesium etc.), and specific morphologies.

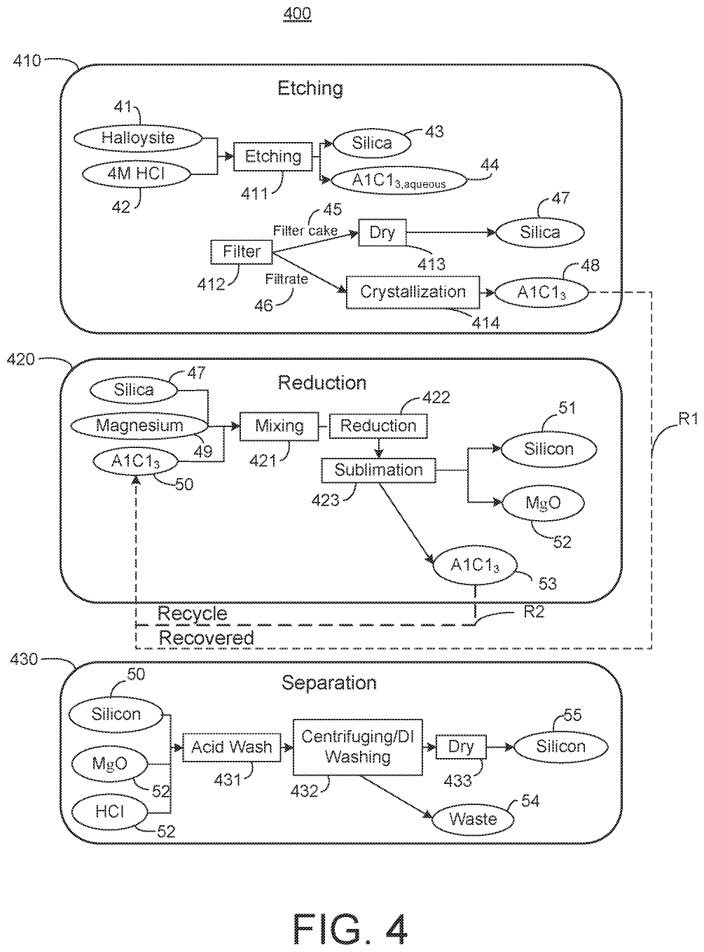

FIG. 4 is a flow diagram schematically illustrating an example method 400 for producing silicon powder (e.g., HDS) from clay minerals (e.g., halloysite and or kaolin). As shown in FIG. 4, the processing steps in method 400 may be categorized or grouped as belonging to one of three distinct stages of processing, i.e., an etching stage 410, a reduction stage 420, and a separation stage 430. Each of the processing steps in the three different stages of processing shown in FIG. 4 (e.g., etching stage 410: steps 411, 412, 413, and 414; reduction stage 420: steps 421, 422, and 423; and separation stage 430: steps 431, 432, and 433) may be annotated with the reactant materials that are input to, and the resulting products that are output by, that processing step. For example, in FIG. 4, etching step 411 in etching stage 410, is shown has having input reactants: halloysite 41 and an acid 42 (e.g., a 4M hydrochloric acid solution). Further, etching step 411 is shown as having resulting products: silica 43 and AlCl₃ 44 (e.g., aqueous AlCl₃).

Example method 400 for producing silicon powder may be implemented in industry scale equipment and can be used to produce large quantities of silicon powder (e.g., several kilograms or tons of silicon powder) in a process cycle.

Etching step 411 in etching stage 410 may correspond to step 110 in method 100 for etching metallic impurities (e.g., aluminum, iron) from an aluminosilicate mineral (e.g., halloysite 41) in a liquid acid etchant (e.g., acid 42).

In example implementations, for improved purity of the silicon powder produced, the liquid acid etchant may be a hydrochloric acid (HCl) solution or a sulphuric acid (H₂SO₄) solution. In the example shown in FIG. 4, the liquid acid etchant may, for example, be a 4 molar (M) concentration aqueous HCl solution.

In example implementations, etching step 411 may be conducted in an autoclave reactor holding the aluminosilicate mineral (e.g., halloysite 41) in the liquid acid etchant (e.g., acid 42) at elevated temperatures and pressures. In example implementations, the etching reactants may be held in the autoclave reactor at 120° C. for about 3 to 15 hours (e.g., 5 hours, 10 hours, etc.). The etching is performed at elevated temperatures (e.g., 120° C.) and pressures (e.g., >1 atmosphere) to decrease the time needed to achieve the product.

In example implementations, the amount of liquid acid etchant used for etching can be stoichiometrically matched to an amount of impurities to be removed from the mineral. The amount of impurities in the mineral may, for example, have been determined by prior chemical assay of the mineral.

In an example implementation, an amount of impurities in 55 grams of halloysite is, for example, stoichiometrically matched with, and etched in, 350 ml of 4 M HCl.

A product of etching step 411 is silica 43 (SiO2). In method 400, this silica 43 is further processed (e.g., in reduction stage 420 and separation stage 430) toward a final HDS product.

Another product of etching step 411 (when the liquid acid etchant is HCl) is an aluminum salt (e.g., AlCl₃) in aqueous solution (e.g., aqueous AlCl₃ 44). In example implementations this AlCl₃ product of etching step 411 can be recovered and recycled for use as a reactant (e.g., as a catalytic reactant in reduction stage 420).

As shown in FIG. 4, etching stage 410 may include a filtration step (e.g., filter 412) to separate silica solids from the liquid acid etchant.

In an example implementation, at filter 412, the end products (e.g., silica 43 and aqueous AlCl₃ 44) of the etching step (i.e., etching 411) may be filtered (e.g., using a Buchner funnel and a vacuum pump) to separate a filter cake 45 contain silica solids from filtrate 46 containing aqueous AlCl₃.

In a next step (e.g., crystallization 414), a solid AlCl₃ salt (i.e., AlCl₃ 48) may be recovered from filtrate 46, for example, by using local heat to evaporate water in filtrate 46 and recover the solid AlCl₃ salts (i.e., AlCl₃ 48) from the aqueous solution. In other example implementations, spray drying (or other larger-scale industrial methods) can be used for evaporating the liquid in filtrate 46 to recover the solid AlCl₃ salts (i.e., AlCl₃ 48).

Further, at a drying step (e.g., dry 413), filter cake 45 may be dried to produce a dry silica cake (e.g., silica 47). In example implementations, filter cake 45 may be dried, for example, in an oven, for 12 hours at 95° C. to remove the water content in filter cake 45 to produce the dry silica cake (e.g., silica 47).

The dry silica cake (e.g., silica 47) can be used as the precursor material for producing HDS, for example, in reduction stage 420. Further, some or all the AlCl₃ salt (i.e., AlCl₃ 48) recovered from filtrate 46 at crystallization 414 can be recycled and used as a heat-absorbing solvent in a metallothermic reducing reaction used in reduction stage 430 to reduce the dry silica cake (e.g., silica 47) to a silicon powder. A recycling path for the recovered AlCl₃ salt (i.e., AlCl₃ 48) is shown in FIG. 4 by a dashed line labelled R1.

In method 400, reduction stage 420 can at a reduction step (e.g., reduction 422) utilize a metallothermic reaction to reduce silica 47 to a silicon powder. All, or only some, of silica 47 may be reduced to silicon powder (in other words, the silicon powder may contain some residual silica).

In example implementations, the metallothermic reaction (e.g., a magnesiothermic reaction) may utilize magnesium (Mg) (e.g., magnesium 49) as a reducing agent. The AlCl₃ salt (e.g., AlCl₃ 50), which has a melting point of about 193° C., may be used as a solvent. In example implementations, at a mixing step (e.g., mixing 421), the reactants (e.g., silica 47, magnesium 49, and AlCl₃ 50) may be pulverized and mixed (e.g., as powders) for the reduction reaction conducted at the reduction step (e.g., reduction 422).

In example implementations, for an example low temperature reduction process, the reactants AlCl₃:SiO₂:Mg may be mixed in a mass ratio of about 40:5:4, respectively, for the metallothermic reduction reaction at the reduction step (e.g., reduction 422). In example implementations, the metallothermic reduction reaction may be conducted in a hydrothermal autoclave (batch) reactor vessel (not shown) at reaction temperatures that are, for example, between about 240° C. and about 340° C.

At least because these reaction temperatures are below the melting temperature of Mg (i.e., 650° C.), the surface area of the Mg (determined, e.g., by the size of the Mg powder particles) in the mix of the reactants AlCl₃:SiO₂:Mg has a strong influence on the reduction reaction rate and the progress of the silicon formation.

In example implementations, the Mg powder used in the reactant mix may have particle sizes, for example, in a range of about 40 to 150 micrometers in diameter. Mg powder with larger particle sizes (i.e., greater than 150 micrometers in diameter) may slow down the reaction rate unacceptably. Mg powder with smaller particle sizes (i.e., smaller than 40 micrometers in diameter) presents a safety hazard with an increasing risk of runaway reactions in the reactor vessel.

The size of AlCl₃ particles in the reactant mix may not be relevant to the reduction reaction rate because AlCl₃ with a melting point of about 193° C. will be in a liquid state at the reaction temperatures. However, in some example implementations, to facilitate even mixing, the AlCl₃ particles may have the same particle size (i.e., about 40 to 150 micrometers in diameter) as the Mg powder used in the reactant mix, or at most a slightly larger particle size (e.g., about 40 to 200 micrometers in diameter)

In example implementations, to prevent further a runway reaction in the reactor vessel, the mass ratio fraction of the heat absorbing AlCl₃ salt can be increased in proportion, for example, to a size of the autoclave reactor. The increased AlCl₃ salt in the reactant mix can help absorb and distribute heat from the reaction. In example implementations, a mass ratio of the reactants AlCl₃:SiO₂:Mg can be about X:5:4, where X (the mass ratio fraction of the AlCl₃ salt) depends on the size (volume) of the autoclave reactor vessel. In example implementations, to prevent a runway reaction in the reactor vessel, X may be no less than 42 for a 100 mL reactor vessel volume, X may be no less than 55 for a 500 mL reactor vessel volume, or X may be no less is no less than 65 for reactor vessel volumes of 50 L or larger. For reactor vessel volumes between 100 ml and 500 ml, and between 500 ml and 50 L, to prevent a runway reaction in the reactor vessel, the minimum values of the mass ratio fraction of the AlCl₃ salt (i.e., X) in the reactants mix may be interpolated between the above-described minimum values (i.e., minimum X=42 for a 100 mL reactor vessel volume, minimum X=55 for a 500 mL reactor vessel volume, and minimum X=65 for a 50 L reactor vessel volume).

In some implementations, the amount of the AlCl₃ salt used for the metallothermic reduction reaction can be increased to be more than the minimum X values needed to prevent a runway reaction in the reactor vessel. However, in general such increases in the amount of the AlCl₃ salt used may be avoided (in other words, only the minimum value of X may be used) to save on material costs, minimize reactor volume, and avoid dilution of reactants.

In example implementations, a batch of the mixed powders (i.e., silica 47, magnesium 49 and AlCl₃ 50) are sealed in a reactor vessel and brought to an elevated reaction temperature. The elevated reaction temperature can be a temperature between about 240° C. and about 340° C. (e.g., 250° C., 270° C., or 300° C.). Reaction times can be between 1 to 12 hours (e.g., 1-3 hours). The reduction reaction may reduce a portion of the silica (e.g., silica 47) to silicon (e.g., silicon 51) while the reducing agent (e.g., magnesium 49) is oxidized to an oxide (e.g., MgO 52). The AlCl₃ salt (i.e., AlCl₃ 50) used as a solvent may remain unchanged in chemical form.

The morphology and nano-structure of the final silicon product (e.g., HDS) depends critically on the temperature of the reduction reaction. In some example implementations, the reaction temperature may be selected to be about 270° C. In some other example implementations, the reaction temperature may be selected to be about 300° C.

In example implementations, heating or temperature gradients in the reactor vessel can play a role in determining a morphology of the final silicon product. The morphology may, for example, change based on whether heat is applied, for example, to a top, a middle, or a bottom of the reactor to set up free-convection currents that determine the progress of liquefaction of the AlCl₃ salt in the reactor vessel. In example implementations, a heating profile for the reactor vessel may be selected to control the progress of liquefaction of the AlCl₃ salt and achieve a specific morphology of the final silicon product.

In an example implementation, a reduction reaction conducted 250° C. can yield silicon (e.g., silicon 51) with a purity of about 75% by mass (the remainder being mostly unreduced silica).

Increasing the reaction temperature (e.g., to 260° C., 270° C., 280° C., 290° C., 300° C., etc.) can increase the purity of the silicon produced by the reaction.

In an example implementation, a reduction reaction conducted at about 270° C. can yield silicon (e.g., silicon 51) with a purity of about 88%, which is higher than the purity (e.g., 75%) obtained at a lower reaction temperatures (e.g., 250° C.).

A reduction reaction conducted at an even higher temperature (e.g., 300° C.) may further increase the purity of the resultant silicon (e.g., silicon 51). On the other hand, a lower reaction temperature (e.g., 250° C.) may yield silicon having a preferred morphological structure for some applications.

In reduction stage 420 of method 400, the AlCl₃ salt (AlCl₃ 50) used as a solvent in the reactor vessel is not consumed in the reaction. In example implementations, all, or some of this unconsumed AlCl₃ salt in the reactor vessel may be recovered and recycled (like the AlCl₃ salt (e.g., AlCl₃ 48) recovered in etching stage 410).

In method 400, AlCl₃ (having a high vapor pressure) in the reactor vessel may be allowed to vaporize or sublimate in appreciable amounts. In example implementations, after reacting for a time at the reduction step (e.g., reduction 422), AlCl₃ in the vapor state may be removed or vented from the reactor vessel (e.g., through a port) at a sublimation or vaporization step (e.g., at sublimation 423) and conveyed to a collection device (not shown). At the collection device, the AlCl₃ vapors can be condensed and collected as a liquid or a solid (depending on the temperature of the collection device).

The removal or venting of AlCl₃ from the reactor vessel can take place during or, after the reduction reaction is complete, while the AlCl₃ is either in a liquid or a solid state inside the reactor vessel. In example implementations, an amount of AlCl₃ removed from the reaction vessel during the reaction can be tuned in proportion to the amounts of silica and Mg reactants remaining, for example, to drive the rate of reaction by increasing a concentration of remaining reactants. Further, in some example implementations, a rate of removal of AlCl₃ may be adjusted to manipulate a porosity and morphology of the silicon produced.

The AlCl₃ salt (AlCl₃ 53) recovered at the sublimation or vaporization step (e.g., at sublimation 423) may, for example, be combined with the AlCl₃ salt (e.g., AlCl₃ 48) recovered in etching stage 410) and recycled for use in future reactions or other applications. A recycling path of the recovered AlCl₃ salt (i.e., AlCl₃ 53) is shown in FIG. 4 by dashed lines labelled R2.

As shown in FIG. 4, next in method 400 separation stage 430 may be directed to separating the silicon (e.g., silicon 51) produced by the reduction reaction in the reactor vessel from the magnesium oxide (e.g., MgO 52) that is also generated by reduction reaction.

In example implementations, at an acid wash step (e.g., acid wash 431), the contents of the reactor vessel (including silicon 51 and MgO 52) may be washed with hydrochloric acid (e.g., HCl 53) to convert the magnesium oxide into water-soluble magnesium chlorides.

In example implementations, the finished reactants (including silicon 51 and MgO 52) in the reactor vessel may be first placed in water to allow any remaining AlCl₃ to react with water. Then, hydrochloric acid (HCl) (e.g., HCl 52) may be added to the reactor vessel to dissolve all magnesium species (i.e., MgO 52) in an acid solution. The amount of HCl added may be sufficient to dissolve all magnesium species in the reactor vessel. Complete dissolution of the MgO 52 present in the reactor vessel may take several hours (e.g., 4 to 5 hrs.).

Further, the contents of the reactor vessel may be washed with water (e.g., deionized (DI) water) and centrifuged (e.g., at a centrifuging and DI washing step 432) to separate or remove liquid acid waste (e.g., waste 54) from the solid contents of the reactor vessel. The water washing may be performed in a centrifuge, which also separates out the completed or final silicon product (e.g., silicon 55) produced by the metallothermic reduction reaction in reduction stage 420.

Further, the washed and separated out silicon product (e.g., silicon 55) may be dried at a drying step (e.g., dry 433), for example, in an oven, for 12 hours at 95° C.

The silicon product (e.g., silicon 55) may include nano-structured silicon particles (e.g., halloysite-derived silicon (HDS) and other forms of nano-silicon). In example implementations, the silicon product (e.g., silicon 55) may include amorphous silicon particles in addition to crystalline silicon particles (e.g., nano-tubes, spheroids, etc.).

The silicon product (e.g., silicon 55) may include an amount of silica in a range of about 5 to 30 weight percentage (in other words, silicon 55 may have a silicon purity in a range of about 70% to 95% corresponding to silica content of 30% to 5%).

For lithium battery anode applications, higher fractions of silicon in the silicon product (used in the battery anode) can provide a greater storage capacity for lithium and exhibit greater reversibility than lower fractions of silicon. Method 400 can achieve silicon purities greater than 75% in the silicon product (e.g., silicon 55) without having to use hydrofluoric acid (HF) to strip off unwanted silica (in other words, method 400 for producing the silicon product (e.g., silicon 55) is HF free). In example implementations, the silicon product (e.g., silicon 55) may have a silicon purity in a range of about 85% to 95%, or equivalently, have silica content in a range of about 5% to 15% by weight.

In processes that, for example, use HF acid to strip off unwanted silica in the silicon product made from clay minerals, the HF acid also attacks and removes amorphous silicon in the silicon product. In contrast, the HF free chemistries used in method 400 preserve the amorphous silicon content of the silicon product (e.g., silicon 55).

In example implementations, method 400 may be implemented to produce a clay mineral-derived silicon product (e.g., HDS) retaining about 5 to 15 wt. % silica in the product.

In some example implementations, method 400 can be used to produce a clay-mineral derived silicon product that includes dopants or other conductive material (e.g., electrically conductive carbon) in addition to silicon and silica.

In example implementations, an oxide of carbon (e.g., graphene oxide, carbon dioxide (CO₂)) can be a source of the electrically conductive carbon included in the clay-mineral derived silicon product. In example implementations, the oxide of carbon source (e.g., graphene oxide) can be reduced (e.g., by a metallothermic reduction reaction) to a reduced oxidation state (e.g., reduced graphene oxide (rGO)) for incorporation into the clay-mineral derived silicon product.

Based on a principle of process intensification (i.e., economically combining two or more chemical processing steps into a single step), the reduction of the oxide of carbon source (e.g., graphene oxide, or CO₂) can be combined with the reduction of silica in method 400.

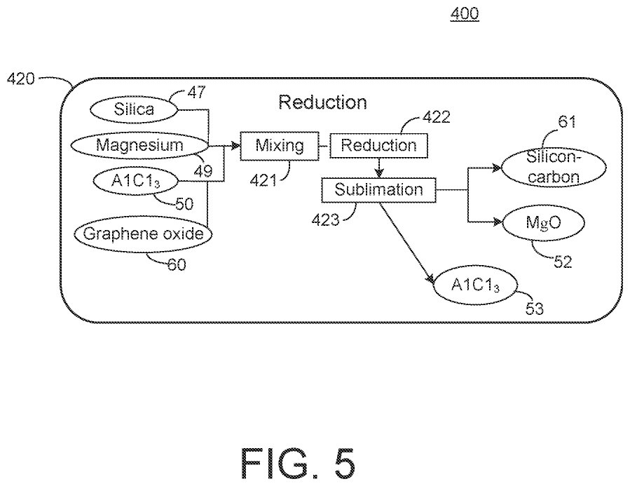

In example implementations, as shown in FIG. 5, an oxide of carbon source (e.g., graphene oxide 60) may be mixed with the other reactants (e.g., silica 47, magnesium 49 and AlCl₃ 50) at mixing step (i.e., mixing 421) and placed in the reactor vessel to undergo reduction (e.g., metallothermic reduction at reduction 422) under the same reaction conditions (e.g., temperatures and pressures) as the reduction of silica 47. Graphene oxide 60 may be reduced to rGO at the same time as silica 47 is converted into silicon by the reduction reaction. The rGO is incorporated in the resulting silicon product (e.g., silicon-carbon 61) without any additional processing steps.

In other implementations, carbon dioxide gas may be used as the source of carbon incorporated in the silicon product (e.g., silicon-carbon 61). The carbon dioxide (CO₂) gas may be introduced in the reactor vessel at the same time as the reduction of silica 47. The CO₂ may to be reduced to a lower oxidation state (e.g., carbon) at the same temperatures and at the same times as the silica 47 is reduced to silicon.

In example implementations, the reduction reaction temperature used for incorporating carbon in the silicon product (e.g., silicon-carbon 61 (silicon with rGO)) may the same temperature used for production of silicon 55 (FIG. 4) (e.g., 260° C., 270° C., 280° C., 290° C., or 300° C., etc.).

In some example implementations, the silicon product (e.g., silicon-carbon 61) may have a weight percentage of carbon content in a range about 2 to 30 wt. % (e.g., 5 to 10 wt. %).

In some example implementations, the chemistries used in method 400 (e.g., in etching stage 410 or in reduction stage 420, FIG. 4) may be modified to produce a clay mineral-derived silicon product (e.g., HDS) including a controlled amount of alumina. The presence of alumina in the silicon product may, for example, provide structural stability to the product. In example implementations, the silicon product (e.g., silicon 55 or silicon-carbon 61) may have a weight percentage of alumina content in a range of about 1 to 15 wt. % (e.g., up to 10 wt. %).

In some example implementations, an alumina content in the silicon product (e.g., silicon 55 or silicon-carbon 61) may be achieved by skipping etching stage 410 completely and proceeding with reduction stage 420 using the unetched clay mineral (instead of the silica 47 shown, for example, in FIG. 4).

In some example implementations, the alumina (or aluminum) content in the silicon product (e.g., silicon 55) may be achieved by replacing HCl as the etchant in etching stage 410 with nitric acid (HNO₃). Reacting the clay mineral with HNO₃ may produce hydroxides of aluminum (e.g., Al(OH₂)) instead of the water soluble AlCl₃ produced using HCl as the etchant.

In some example implementations, powdered aluminum metal may be used as a reducing agent (replacing magnesium) in the metallothermic reduction reactions used in reduction stage 420 (FIG. 4) to reduce the clay mineral into the silicon product (e.g., silicon 51). Using powdered aluminum metal may be less expensive than using magnesium metal as the reducing agent. Furthermore, using powdered aluminum metal as the reducing agent may leave more alumina in the finished silicon product to promote structural stability.

Sodium chloride (NaCl) salt costs less than AlCl₃ salt. In some example implementations, NaCl salt may be mixed with the AlCl₃ salt that is used as a solvent for the magnesiothermic reduction reaction (e.g., at reduction 422, FIG. 4). The mixed NaCl—AlCl₃ salts may serve the same purpose as pure AlCl₃ salt, i.e., to function as a solvent for the magnesiothermic reduction reaction, and to store and transport heat from the exothermic magnesiothermic reduction reaction.

The NaCl—AlCl₃ salt mixture may have a eutectic or a near-eutectic salt composition that has a lower melting temperature than the melting temperature (i.e., 193° C.) of pure AlCl₃. A 22 wt. % of NaCl in the salt mixture corresponds to a eutectic composition with AlCl₃ having a melting temperature of about 108° C. Using the eutectic or a near-eutectic NaCl—AlCl₃ salt mixture instead of pure AlCl₃ salt (as the solvent for the magnesiothermic reduction reaction) would decrease the total pressure inside the heated reactor vessel because NaCl has a lower vapor pressure than the vapor pressure of AlCl₃. Conducting the reduction reaction at lower temperatures and pressures by incorporating NaCl in the salt/solvent mixture can decrease material costs of the process and may further promote a tubular or rod-like structure of the resulting silicon (HDS).

In some example implementations, an amount of NaCl included in the salt/solvent mixture can be in a range of 0 to 25 wt. % NaCl in AlCl₃.

Above 13 wt. % NaCl the partial pressure of AlCl3 inside the reactor can be less than 1 atmosphere, which may make it difficult to remove or vent AlCl₃ in a vapor state from the reactor vessel (e.g., through a port) at a sublimation or vaporization step (e.g., at sublimation 423, FIG. 4).

In some example implementations, the amount of NaCl included in the salt/solvent mixture can be kept below 13 wt. % NaCl in AlCl₃ (in other words, in a range of 0 to 13 wt. % NaCl in AlCl₃), for example, to avoid difficulties in removing or venting AlCl₃ in a vapor state from the reactor vessel.

While halloysite is used as an example aluminosilicate clay mineral to illustrate the foregoing methods for producing nano-structured silicon products, it will be understood that the foregoing methods may be used for producing nano-structured silicon products from any type of aluminosilicate clay mineral including, for example, kaolinite. Nano-structured silicon products derived for kaolinite may, for example, include plate-like silicon peds or particles.

It will be understood that, in this description, when an element, such as a layer, a region, or a substrate, is referred to as being on, connected to, electrically connected to, coupled to, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
etching metallic impurities from an aluminosilicate mineral in a liquid acid etchant;
separating solids including silica from the liquid acid etchant;
reducing the silica in the separated solids to silicon using a solid reducing agent resulting in a silicon-residual silica composite;
removing aluminum chloride from the silicon-residual silica composite;
dissolving oxides of the solid reducing agent in an acid solution;
separating silicon-residual silica solids remaining in the acid solution from the acid solution; and
drying the separated silicon-residual silica solids to produce a clay mineral-derived silicon product.

2. The method of claim 1, wherein the aluminosilicate mineral includes at least one of a halloysite or a kaolinite mineral.

3. The method of claim 1, wherein the liquid acid etchant and the acid solution are hydrofluoric acid free.

4. The method of claim 1, wherein an amount of the liquid acid etchant is stoichiometrically matched to an amount of the metallic impurities to be removed from the aluminosilicate mineral.

5. The method of claim 1, wherein the liquid acid etchant is one of hydrochloric acid (HCl), nitric acid (HNO₃), or sulfuric acid (H₂SO₄).

6. The method of claim 1, wherein etching the metallic impurities from the aluminosilicate mineral in the liquid acid etchant includes conducting the etching at a temperature of at least 120° C. for at least 1 hour.

7. The method of claim 1, wherein the liquid acid etchant is hydrochloric acid (HCl) and etching the metallic impurities from the aluminosilicate mineral in the liquid acid etchant results in an aqueous solution of aluminum chloride, and the method further includes recovering solid aluminum chloride salts from the aqueous solution.

8. The method of claim 1, wherein the solid reducing agent is one of magnesium or aluminum.

9. The method of claim 1, wherein reducing the silica in the separated solids to the silicon using the solid reducing agent includes using aluminum chloride as a solvent for a metallothermic reduction reaction between the silica and the solid reducing agent.

10. The method of claim 9, wherein using aluminum chloride as a solvent for the metallothermic reduction reaction between the silica and the solid reducing agent includes using a mixture of aluminum chloride and sodium chloride as the solvent.

11. The method of claim 9, wherein the solid reducing agent is magnesium, and reducing the silica in the separated solids to the silicon includes mixing the silica, the magnesium, and the aluminum chloride in a mass ratio of about 5:4:X, where X is a mass ratio fraction of the aluminum chloride and is no less than about 42.

12. The method of claim 11, wherein mixing the silica, the magnesium, and the aluminum chloride includes mixing the magnesium in a powder form having particle sizes in a range of about 40 to 150 micrometers in diameter.

13. The method of claim 9, further comprising:
conducting the metallothermic reduction reaction in a reactor vessel at a selected reaction temperature between 260° C. and 340° C., the selected reaction temperature determining a nano-structure and morphology of the clay mineral-derived silicon product.

14. The method of claim 13, further comprising: establishing a temperature distribution in the reactor vessel to generate free convention currents for progressive liquefaction of the aluminum chloride in the reactor vessel.

15. The method of claim 13, further comprising, recovering unconsumed aluminum chloride from the reactor vessel, during the metallothermic reduction reaction, or after the metallothermic reduction reaction is completed.

16. The method of claim 15, wherein recovering unconsumed aluminum chloride from the reactor vessel includes removing an amount of the unconsumed aluminum chloride in a vapor state through a port of the reactor vessel.

17. The method of claim 16, further comprising:
controlling the amount of the unconsumed aluminum chloride removed through the port of the reactor vessel to drive a rate of reaction of the silica and magnesium remaining in the reactor vessel.

18. The method of claim 16, further comprising, controlling a rate of removal of the unconsumed aluminum chloride to manipulate a porosity and a morphology of a silicon product produced by the metallothermic reduction reaction.

19. The method of claim 1, further comprising:
incorporating electrically conductive carbon in the clay mineral-derived silicon product by reducing an oxide of carbon together with reducing the silica.

20. The method of claim 19, wherein the oxide of carbon is graphene oxide and or carbon dioxide (CO₂).

21. The method of claim 19, wherein the oxide of carbon includes graphene oxide and the electrically conductive carbon incorporated in the clay mineral-derived silicon product is reduced graphene oxide (rGO).

22. The method of claim 19, wherein up to 10 weight percent of reduced graphene oxide is incorporated in the clay mineral-derived silicon product.

23. A clay mineral-derived silicon product prepared by a hydrofluoric acid (HF)-free process, the product comprising:
silicon nano structures; and
silica in a range of about 5 to 25 weight percentage of the product.

24. The clay mineral-derived silicon product of claim 23, wherein the silica comprises about 5 to 12 weight percentage of the product.

25. The clay mineral-derived silicon product of claim 23, wherein the silicon nano structures include silicon nano tubes and nano-size silicon spheres and particles.

26. The clay mineral-derived silicon product of claim 23, wherein the silicon nano structures include amorphous silicon particles.

27. The clay mineral-derived silicon product of claim 23, further comprising:
electronically conductive carbon mixed with the silicon nano structures.

28. The clay mineral-derived silicon product of claim 27, wherein the electronically conductive carbon includes reduced graphene oxides (rGO).

29. The clay mineral-derived silicon product of claim 28, wherein the electronically conductive carbon comprises 2 to 30 weight percent of the product.

30. The clay mineral-derived silicon product of claim 23, further comprising:
alumina mixed with the silicon nano structures.

31. The clay mineral-derived silicon product of claim 30, wherein the alumina comprises up to about 10 weight percent of the product.

32. The clay mineral-derived silicon product of claim 23, wherein the silicon nano structures, and the silica are prepared by:
etching metallic impurities from an aluminosilicate mineral in a liquid acid etchant;
separating solids including silica from the liquid acid etchant;
reducing the silica in the separated solids to silicon using a solid reducing agent resulting in a silicon-residual silica composite;
removing aluminum chloride from the silicon-residual silica composite;
dissolving oxides of the solid reducing agent in an acid solution;
separating silicon-residual silica solids remaining in the acid solution from the acid solution; and
drying the separated silicon-residual silica solids to produce the clay mineral-derived silicon product.
